(19) United States
(12) Patent Application Publication
(10) Pub. No.: US 2016/0134753 A1
(43) Pub. Date: May 12, 2016

(54) PERSONNEL ALLOCATION PLANNING DEVICE, METHOD AND PROGRAM

(71) Applicant: P&W Solutions Co., Ltd., Tokyo (JP)

(72) Inventor: Toshiyuki Omiya, Tokyo (JP)

(21) Appl. No.: 14/931,643

(22) Filed: Nov. 3, 2015

Related U.S. Application Data
(63) Continuation of application No. PCT/JP2015/059215, filed on Mar. 25, 2015.

(30) Foreign Application Priority Data
Mar. 27, 2014 (JP) 2014-065550
Apr. 30, 2014 (JP) 2014-093540

(51) Int. Cl. H04M 3/51; G06Q 10/06

(52) U.S. Cl. CPC H04M 3/5175; G06Q 10/063112; G06Q 10/063118

(57) ABSTRACT

A device, method and program for personnel allocation planning are provided, with which the personnel allocation planning is easily and appropriately carried out with prospective ROI, and is based on actual achievement by the staff members to be allocated, thereby improving the certainty. An individual efficiency calculation unit 2 calculates the factors for return on investment on each of the plurality of staff members at the contact center. For example, the individual efficiency calculation unit 2 calculates at least one of production efficiency, achievement efficiency and quality efficiency, as the factors of return on investment. A personnel allocation unit 1 calculates indexes of return on investment, based on a result of calculation by the individual efficiency calculation unit 2, and plans allocation of each of the plurality of staff members, based on the indexes of return on investment.

### CROSS-REFERENCE TO RELATED APPLICATIONS

This application claims the benefit of priority under 35 U.S.C. §365(c) and §120 as a continuation of PCT/JP2015/059215 filed on Mar. 25, 2015, which claims the benefit of priority to Japanese Patent Application No.: 2014-065550 filed Mar. 27, 2014 and Japanese Patent Application No.: 2014-093540 filed Apr. 30, 2014. The full contents of the International Application are incorporated herein by reference.

### TECHNICAL FIELD

The present invention relates to personnel allocation planning device, method and program.

### BACKGROUND ART

In recent years, contact centers (call centers) have begun to occupy an important position in companies, as customer technical support desks.

Therefore, it has been conventionally required to appropriately allocate (schedule) agents (also referred to as operators or communicators; hereinafter referred to as “staff members”) at the contact center. Conventionally, WFM (Workforce Management) has been used to obtain a required number of staff members.

Namely, Erlang C has been used to obtain the number of staff members, which is required to achieve a response rate at a target service level, based on a predicted number of call to be taken (refer to Patent Document 1).

Patent Document 1: Japanese Unexamined Patent Application, Publication No. 2007-142502

### DISCLOSURE OF THE INVENTION

### Problems to be Solved by the Invention

However, the WFM employs a method of calculating a required number of staff members through Erlang C, based on a predicted number of call to be taken; therefore, the waiting-line probability is calculated in relation to the call-taking probability, which does not consider production efficiency of actual call-taking by staff members to be allocated, and as a result, the uncertainty has been calculated in a duplicated manner.

It has been conventionally said that the use of WFM would enable optimal allocation in terms of personnel allocation and the predicted number of call to be taken; however, substantially no contact centers actually employ the personnel allocation as shown in FIG. 17.

FIG. 17A and FIG. 17B are diagrams showing examples of the personnel allocation planning through the conventional WFM.

FIG. 17A shows an example of personnel allocation in the case of not carrying out the personnel allocation planning. The horizontal axis shows the time zone, and the vertical axis shows the number of staff. Namely, in the case of not carrying out the personnel allocation planning, the same number of staff members is uniformly allocated to all of the time zones. Here, a region 102 shows the required number of staff members corresponding to the number of call-taking, which is obtained through the Erlang C. Namely, the staff members, who are allocated in a region 101, become unnecessary staff members allocated.

FIG. 17B shows an example of personnel allocation in the case of following the personnel allocation planning through the conventional WFM. The horizontal axis shows the time zone, and the vertical axis shows the number of staff. The region 103 is identical to the region 102, and shows the required number of staff members corresponding to the number of call-taking, which is obtained through the Erlang C. However, the values in the region 102 may include decimal fractions depending on the time zone; however, the number of staff to be allocated is actually represented in integer values in the region 102, as shown in a region 104.

The personnel allocation as shown in FIG. 17 can be carried out by using the WFM. However, in reality, WFM has not been used at contact centers, which have contrived ways to shift-working from the stage of employing their staff members, such that their personnel allocation can cope with the number of call-taking. Namely, only a function of the WFM has been used to create a shift schedule, based on rules such as repetition; resulting in a situation where a suitable return on investment (ROI) cannot be expected.

In order to solve the problems as described above, the present invention makes it possible to easily and appropriately carry out the personnel allocation planning with prospective ROI.

### Means for Solving the Problems

In the personnel allocation planning device of the present invention, target service levels are defined as factors of return on investment for production efficiency, achievement efficiency, quality efficiency, etc.

Here, the technique to calculate the factors for return on investment is not limited in particular; and for example, an illustrative example thereof may be as described below, in terms of the production efficiency, the achievement efficiency, and the quality efficiency.

For the purpose of calculating the production efficiency, the productivity of staff member to be allocated is obtained, based on the number of call-taking during a certain period of time, from switchboards such as PBX and CTI.

For the purpose of calculating the achievement efficiency, such achievement is obtained based on information such as the number of successful contracts during a certain period of time, which is acquired from the sales management system.

For the purpose of calculating the quality efficiency, an evaluation is obtained based on a result of monitoring contact status, and an evaluation according to a customer follow-up survey.

In this manner, the personnel allocation planning device of the present invention is a device, which can pursue ROI by precisely allocating staff members in the required time zones, when creating the personnel allocation planning, in consideration of the performance of individual staff members, such as productivity, achievement, and quality. In other words, the personnel allocation planning device of the present invention is a device, which can carry out the personnel allocation planning through PPM (Performance Portfolio Management).

A personnel allocation planning device according to one aspect of the present invention is a personnel allocation planning device for planning allocation of staff members at a contact center, the device comprising: an efficiency calculation unit that calculates three factors composed of production efficiency, achievement efficiency and quality efficiency, as factors for return on investment on each individual of a plurality of staff members at the contact center; and a personnel allocation unit that calculates three indexes corresponding to the three factors, based on a result of calculation by the efficiency calculation unit, compares the three indexes with the three factors for each of the plurality of staff members, and plans allocation of each of the plurality of staff members, based on a result of the comparison.

The personnel allocation unit can compare an operator vector composed of the three factors, and an index vector composed of the three indexes, for each of the plurality of staff members; and can plan allocation of each of the plurality of staff members, based on a result of the comparison.

The personnel allocation planning device further comprises an assignment unit that determines an assignment degree regarding the three factors; in which the personnel allocation unit can compare the three indexes with the three factors for each of the plurality of staff members, based on the result of calculation by the efficiency calculation unit, and based on the assignment degree determined by the assignment unit; and can calculate the indexes of return on investment, based on a result of the comparison.

The personnel allocation planning device further comprises a time zone designation unit that designates at least one time zone, for which the three indexes of return on investment are calculated; in which the assignment unit can determine the assignment degree for each of the at least one time zone designated by the time zone designation unit; and the personnel allocation unit can calculate the three indexes of return on investment, based on the assignment degree determined by the assignment unit, for each of the at least one time zone designated by the time zone designation unit.

The personnel allocation planning device further comprises a regulation compliance calculation unit that calculates a condition for compliance to regulations regarding workers; in which the personnel allocation unit can calculate a regulation compliance index, based on a result of calculation by the regulation compliance calculation unit; and can plan allocation of each of the plurality of staff members, based on the regulation compliance index, and based on the three indexes of return on investment.

The personnel allocation planning device further comprises an equitability calculation unit that calculates a condition for equitability of workers, in which the personnel allocation unit can calculate an equitability index, based on a result of calculation by the equitability calculation unit; and can plan allocation of each of the plurality of staff members, based on the equitability index, and based on the three indexes of return on investment and the regulation compliance index.

A personnel allocation planning method and program according to one aspect of the present invention are a method and program corresponding to the personnel allocation planning device according to the aforementioned one aspect of the present invention.

### Effects of the Invention

According to the present invention, the personnel allocation planning can be easily and appropriately carried out with prospective ROI, and is based on actual achievement by the staff members to be allocated, thereby improving the certainty.

### BRIEF DESCRIPTION OF THE DRAWINGS

FIG. 1 is a functional block diagram of a device as an example of a preferred embodiment of the present invention;

FIG. 2 is a diagram showing an example of personnel allocation in a case of following the personnel allocation planning through PPM, which is based on production efficiency based on the number of call-taking;

FIG. 3 is a diagram showing a concept of ROI;

FIG. 4 shows an example of personnel allocation in a case of following the personnel allocation planning through the PPM, based on production efficiency, achievement efficiency, and quality efficiency;

FIG. 5 shows a concept of the personnel allocation planning through the PPM, to which the present invention is applied;

FIG. 6 is a diagram for illustrating a technique to generate an ROI retrospective vector Va;

FIG. 7 is a diagram showing the ROI retrospective vector Va thus generated;

FIG. 8 is a table showing each of (A) the production efficiency, (B) the achievement efficiency, and (C) the quality efficiency, for each operator to be allocated as a staff member;

FIG. 9 is a table showing each of (A) the production efficiency, (B) the achievement efficiency, and (C) the quality efficiency, for each operator to be allocated as a staff member, in which the data in the table is sorted in descending order of the ROI in consideration of the priority;

FIG. 10 shows a table, excluding the operators who were identified as having constraints from the table of FIG. 9;

FIG. 11 is a table showing eight operators who were selected as staff members by a personnel allocation unit;

FIG. 12 shows a specific technique of the personnel allocation planning through the PPM, to which the present invention is applied;

FIG. 13 is a list of designated time, to which the assignment is applied;

FIG. 14 is a diagram showing a GUI for an administrator or the like to designate the designated time, to which the assignment is applied;

FIG. 15 is another diagram showing a GUI for an administrator or the like to designate the designated time, to which the assignment is applied;

FIG. 16 is still another diagram showing a GUI for an administrator or the like to designate the designated time, to which the assignment is applied; and

FIG. 17A is a diagram showing an example of personnel allocation in the case of not carrying out personnel allocation planning

FIG. 17B shows an example of personnel allocation in the case of personnel allocation planning using conventional WFM.

### PREFERRED MODE FOR CARRYING OUT THE INVENTION

An embodiment of the present invention is described below with reference to the drawings on the basis of examples.

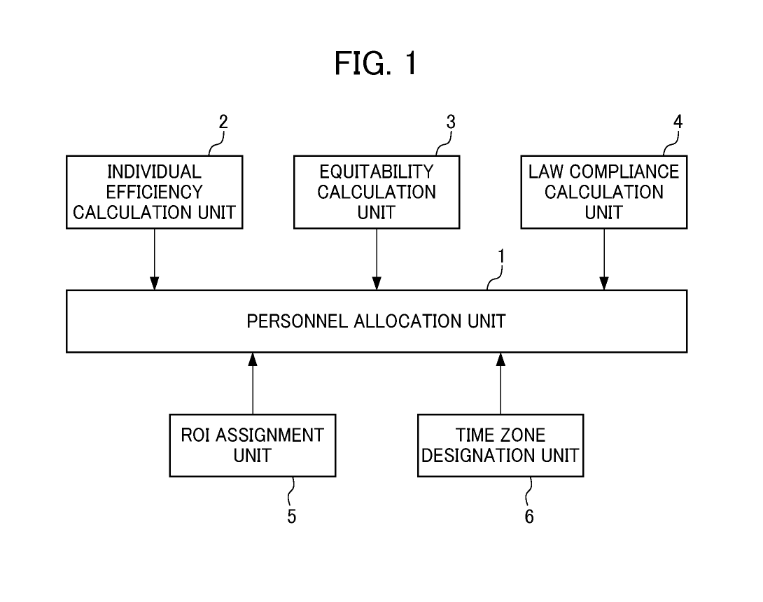

FIG. 1 is a diagram showing an overview of a functional block of a personnel allocation planning device according to an example of a preferred embodiment of the present invention.

The personnel distribution planning device is configured to include a personnel allocation unit 1, an individual efficiency calculation unit 2, an equitability calculation unit 3, a law compliance calculation unit 4, an ROI assignment unit 5, and a time zone designation unit 6.

The term “include” is used herein, since, naturally, there may be any other functional blocks including any other functions.

Namely, these units (the personnel allocation unit 1 to the time zone designation unit 6) are composed of a central processing unit (CPU) that computes and processes information. In other words, the central processing unit controls the entirety of the personnel allocation planning device, and has these units (the personnel allocation unit 1 to the time zone designation unit 6) in order to achieve some of the functions thereof.

The central processing unit reads and executes various programs stored in a storage unit (not shown) as appropriate, thereby collaborating with the aforementioned hardware, and realizing various functions according to the present invention. Namely, in the present embodiment, these units (the personnel allocation unit 1 to the time zone designation unit 6) are realized by a combination of hardware such as CPU, etc. with software.

The storage unit (not shown) may include: local memory to be used for the execution of programs in combination with the central processing unit; large-capacity bulk memory; and cache memory to be used for efficiently searching the bulk memory. The storage unit stores various programs to be executed. A computer-readable medium (storage medium) for realizing the storage unit may include a medium, which is realized in an electrical, magnetic, optical, or electromagnetic manner. More specifically, such a medium includes semiconductor memory, magnetic tapes, magnetic disks, random access memory (RAM), read-only memory (ROM), and optical disks including CD-ROM, CD-R/W and DVD.

The personnel allocation planning device includes an input unit and an output unit (not shown).

The input unit is intended to receive an input from an administrator or the like, and may include a keyboard, a pointing device, etc.

The output unit displays a screen for receiving a data input from an administrator or the like, or a screen for showing results of arithmetic processing by the central processing unit, and includes a display device such as a cathode ray tube display (CRT) or a liquid crystal display (LCD).

The personnel allocation planning device having such a functional configuration of FIG. 1 is a device capable of personnel allocation planning through PPM, namely, a device equipped with a new engine (units including the personnel allocation unit 1 to the time zone designation unit 6); in which the new engine will lead the contact center to the ROI-centered innovation.

Here, the PPM differs from the conventional WFM, in the following points.

Namely, the conventional WFM follows the processing flow from (1) to (3) as follows.

(1) Predict the number of call-taking;

(2) Calculate the number of staff necessary to perform the call-taking operation, in order to achieve a required service level such as a required response rate; and

(3) Schedule the number of staff required.

In contrast, the PPM follows the processing flow from (1) to (2) as follows.

(1) Predict the individual requirements such as skills, productivity and sales competence, based on the number of call-taking in the past; and

(2) Schedule personnel allocation so as to maximize the required result, for each particular person who has the skills, productivity and sales competence.

In other words, instead of scheduling the number of staff to the time zone from the perspective of the number of call-taking, the PPM schedules the most effective personnel allocation to the time zone (time, day of week, date or the like) from the perspective of ROI (return on investment).

Here, in the PPM, the ROI factors are roughly classified into (A) to (C) as follows.

(A) Production efficiency;

(B) Achievement efficiency; and

(C) Quality efficiency.

First of all, (A) the production efficiency is described.

Here, (A) the production efficiency can also be further classified into (A-1) and (A-2) as follows.

(A-1) Production efficiency, based on the number of call-taking; and

(A-2) Production efficiency, based on the number of transactions for each type of inquiry.

(A-1) The production efficiency, based on the number of call-taking, is obtained by calculating the number of call-taking/cost, for each staff member.

By referring to the (A-1) production efficiency calculated for each staff member, for example, a staff member having high production efficiency can be preferentially allocated in the peak call-taking time zone. In this case, the unit cost of each individual staff member does not significantly change, and the number of transactions is increased without increasing the cost; therefore, the cost-performance can be maximized

Specifically, if a staff member having the production efficiency 1.6 times higher than the average production efficiency is allocated in the peak call-taking time zone, in place of a staff member having the average production efficiency, the cost could be theoretically reduced to 62.5%.

(A-2) The production efficiency, based on the number of transactions for each type of inquiry, is obtained by calculating the number of transactions/cost, for each staff member and each type of inquiry.

For example, assume that types of inquiries have already been analyzed in terms of the past statistical data. In this case, this task can be realized by: identifying a type of inquiry that is most frequently asked during each time zone (time, day of week, date or the like); referring to (A-2) the production efficiency; and preferentially allocating staff members having high production efficiency in terms of the identified type of inquiry (staff members who excel at the transaction for the identified type of inquiry), until achieving the response rate.

(B) The achievement efficiency is obtained by calculating sales achievement or a number of entrustment/cost, for each staff member.

For example, assume that types of inquiries have already been analyzed in terms of the past statistical data. In this case, by identifying a time zone (time, day of week, date or the like) in which the number of successful contracts is maximized, and referring to (B) the achievement efficiency, staff members having high achievement efficiency can be preferentially allocated in the identified time zone.

Here, (B) the achievement efficiency can also be further classified into (B-1) to (B-4) as follows.

(B-1) Successful contract rate;

(B-2) Up-selling rate;

(B-3) Cross-selling rate; and

(B-4) Membership recommendation rate.

(C) The quality efficiency is calculated for each staff member, as an index of human skills such as courteous reception and capability of adapting to circumstances. The calculation technique is not limited in particular; and, for example, a calculation technique based on evaluation by an administrator can be employed.

The number of staff members is limited, in terms of the requirements such as individual call-taking contents and desired effects ((A) the production efficiency and (B) the achievement efficiency); therefore, if such requirements cannot be satisfied, (C) the quality efficiency can be utilized, in order to allocate staff members having the human skills such as courteous reception and capability of adapting to circumstances.

Here, the cost reduction effects can be achieved, even if the personnel allocation planning is carried out through the PPM which employs arbitrary one of the three ROI factors (A) to (C).

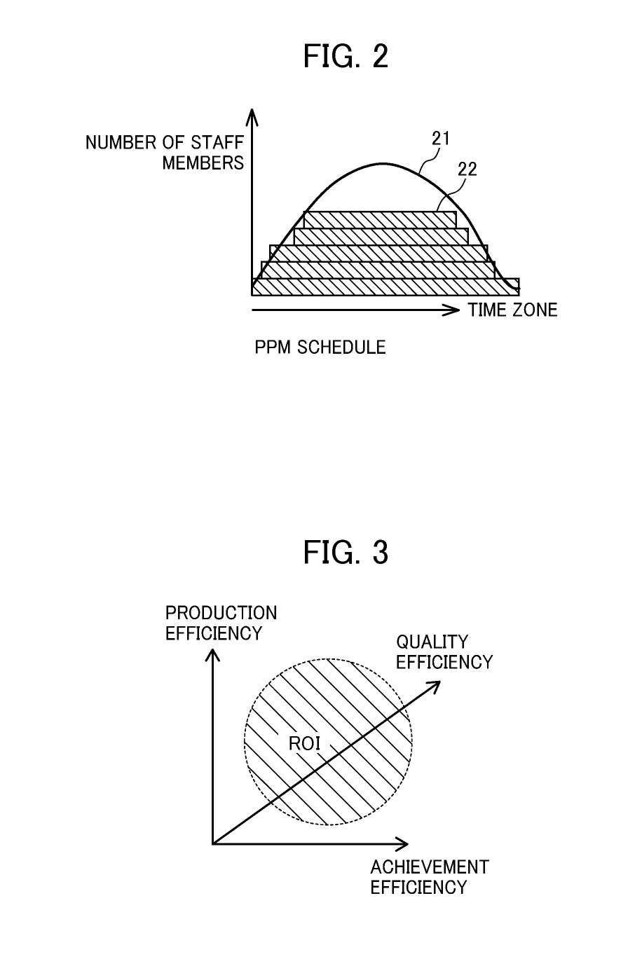

FIG. 2 shows an example of personnel allocation in the case of following the personnel allocation planning through the PPM, which is based on (A-1) the production efficiency based on the number of call-taking. The horizontal axis shows the time zone, and the vertical axis shows the number of staff.

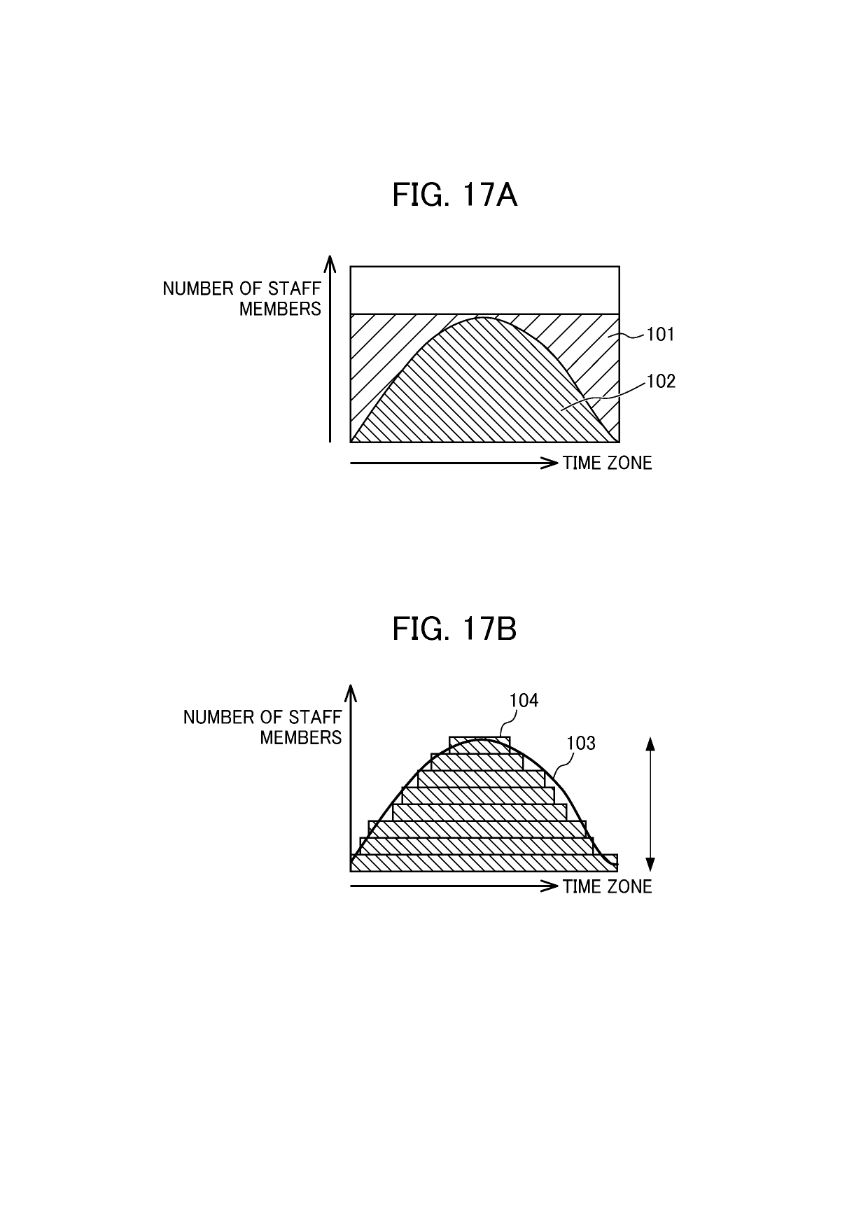

A region 21 is identical to a region 102 of FIG. 17, and shows the required number of staff members corresponding to the number of call-taking, which is obtained through the conventional WFM.

In the example of FIG. 2, in order to optimize (A-1) the production efficiency based on the number of call-taking, the staff members are sequentially assigned to the shift, such that the higher (A-1) the production efficiency is, the longer the working hours are (the longer bars show the longer hours downward in FIG. 2), until achieving the response rate, which is one of the target service levels. A region 22 shows the personnel allocation, which is obtained in this manner.

Namely, the personnel allocation through the conventional WFM is the region 104 of FIG. 17 (B); whereas the personnel allocation through the PPM based on (A-1) the production efficiency based on the number of call-taking, to which the present invention is applied, is the region 22 of FIG. 2. The cost is roughly calculated by the number of staff×(multiplied by) the working hours; therefore, the larger the area of personnel allocation is, the higher the cost will be. It is understood that the region 104 of FIG. 17B is larger in area, and is therefore higher in cost, than the region 22 of FIG. 2. The cost performance is further improved by preferentially allocating the staff members whose productivity is higher and unit cost (hourly rate) is lower. In other words, the cost can be significantly reduced as compared to the conventional WFM, by carrying out the personnel allocation planning through the PPM, based on (A-1) the production efficiency based on the number of call-taking, to which the present invention is applied.

Here, the higher effects are achieved by simply optimizing (A) the production efficiency than by the conventional WFM; therefore, if such effects are sufficient, the staff members may be sequentially allocated in descending order of production efficiency, and shift-working hours, and ascending order of hourly rates.

However, as shown in FIG. 3, (A) the production efficiency is only of the ROI factors.

Namely, FIG. 3 is a diagram showing the concept of ROI.

As shown in FIG. 3, the ROI is defined by vectors (dots) in a three-dimensional space, the vectors being represented by (A) the production efficiency, (B) the achievement efficiency, and (C) the quality efficiency, respectively.

Therefore, the ROI will be more remarkable by carrying out the personnel allocation planning, such that (A) the production efficiency, (B) the achievement efficiency, and (C) the quality efficiency are allocated in a balanced manner, so as to be optimized from a comprehensive perspective. For example, in the example of FIG. 3, the coordinates of the vectors define a point in the three-dimensional space, and represent (A) the production efficiency, (B) the achievement efficiency, and (C) the quality efficiency, respectively; therefore, by specifying a desired dot within the sphere shown by the dotted line, a desired ROI can be easily obtained.

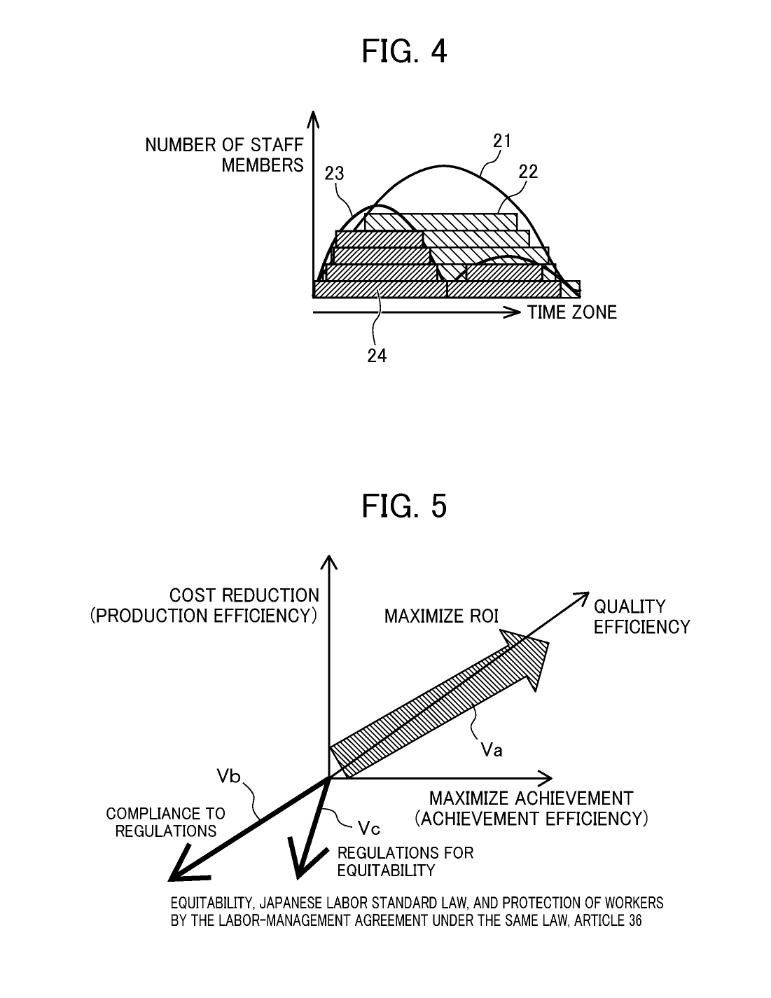

FIG. 4 shows an example of personnel allocation in the case of following the personnel allocation planning through the PPM, based on (A) the production efficiency, (B) the achievement efficiency, and (C) the quality efficiency. The horizontal axis shows the time zone, and the vertical axis shows the number of staff.

The region 21 is identical to the region 21 of FIG. 2, and shows the required number of staff members corresponding to the number of call-taking, which is obtained through the conventional WFM. The region 22 is identical to the region 22 of FIG. 2, and shows the personnel allocation through the PPM that is only based on (A) the production efficiency.

A region 23 shows the number of results by time zones, as obtained from the mission critical system in the past, and shows, for example, the number of call-taking for car accidents that required towing services, among the number of call-taking involved with automobile insurance. However, the values in the region 23 may include decimal fractions depending on the time zone; however, the number of staff allocation is actually represented in integer values in the region 23, as shown in a region 24.

This makes it possible to, for example, follow the region 24 to allocate the staff members, who excel at call-taking for towing services (such skills are determined based on, for example, (B), (C), etc.), and who are highly capable of handling (such skills are determined based on, for example, (A-2), etc. regarding inquiries about towing services), in the time zone during which towing services would be required. Meanwhile, it is possible to follow the region 22 to allocate the staff members, who are highly capable of call-taking (such skills are determined based on, for example, (A-1), etc.) in the peak call-taking time zone.

However, it is required to protect the workers, from the perspective of equitability, and under the Japanese Labor Standard Law, the labor-management agreement under the same Law, Article 36, etc. Namely, carrying out personnel allocation planning, which pursues only ROI (return on investment), is not allowed.

FIG. 5 shows a concept of the personnel allocation planning through the PPM, to which the present invention is applied.

As shown in FIG. 5, the personnel allocation planning is carry out from the perspective of a resultant vector that combines a vector Va obtained from the perspective of maximizing the ROI, with vectors Vb and Vc obtained from the perspective of the protection of workers.

Here, the vector Vb is obtained from the perspective of compliance with the regulations for the protection of workers, such as the Japanese Labor Standard Law, the labor-management agreement under the same Law, Article 36, etc. The vector Vc is obtained from the perspective of the weight on each condition for the equitability regarding the protection of workers (i.e. the degree to which the regulations should be observed).

Specifically, the individual efficiency calculation unit 2 of FIG. 1 calculates (A) the production efficiency, (B) the achievement efficiency, and (C) the quality efficiency, for each staff member.

The equitability calculation unit 3 calculates the weight on each condition for the equitability regarding the protection of workers (i.e. the degree to which the regulations should be observed).

The law compliance calculation unit 4 calculates a condition for the compliance of the regulations regarding the protection of workers, such as the Japanese Labor Standard Law, the labor-management agreement under the same Law, Article 36, etc.

The ROI assignment unit 5 assigns priority and allocation to each of the ROI factors calculated by the individual efficiency calculation unit 2.

The personnel allocation unit 1 obtains an ROI index (vector Va of FIG. 5), based on results of calculation by the individual efficiency calculation unit 2 and the ROI assignment unit 5; and obtains worker protection indexes (vectors Vb and Vc of FIG. 5), based on results of calculation by the equitability calculation unit 3 and the law compliance calculation unit 4. The personnel allocation unit 1 creates the personnel allocation planning, based on the ROI index (vector Va of FIG. 5) and the worker protection indexes (vector Vb and Vc of FIG. 5).

Further, the personnel allocation planning is described below in detail.

Here, the vector Va serving as the ROI index is hereinafter referred to as “retrospective vector Va”.

The ROI retrospective vector Va refers to a vector serving as an index (ideal index vector), which shows the personnel allocation that could have been ideal for the administrator (personnel allocation planner), in a case in which the requirements such as regulations or equitability have been disregarded.

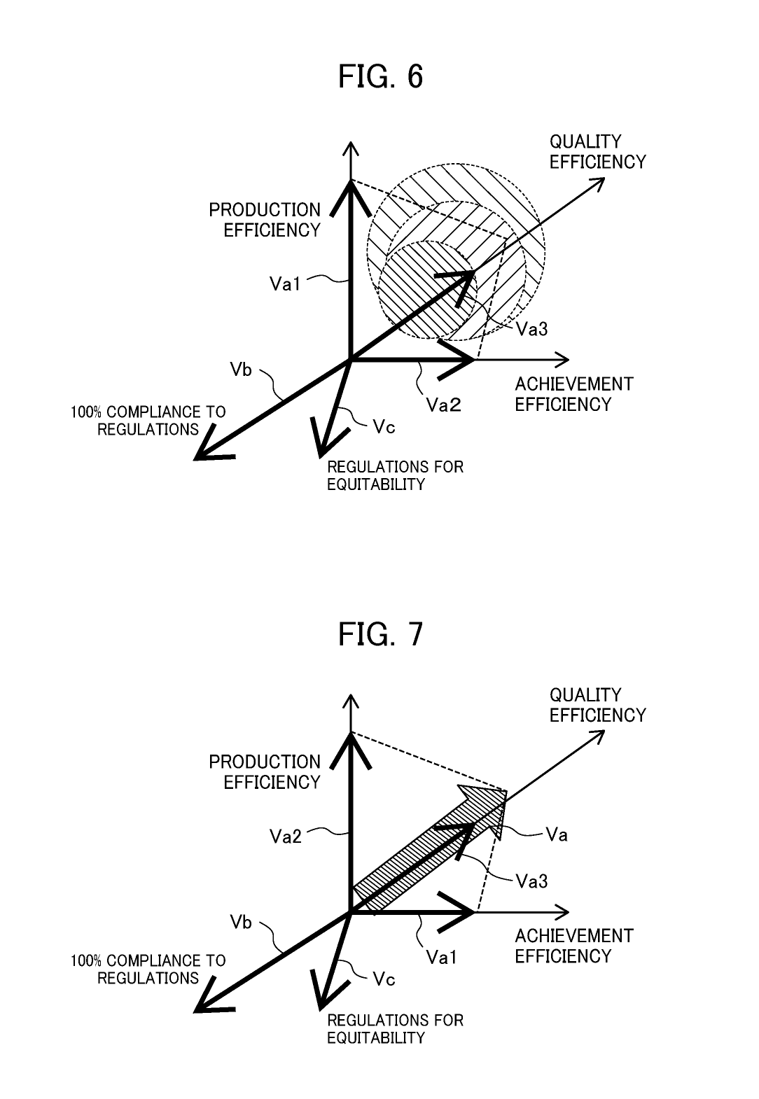

FIG. 6 is a diagram for illustrating a technique to generate the ROI retrospective vector Va.

FIG. 7 is a diagram showing the ROI retrospective vector Va thus generated.

As shown in FIGS. 6 and 7, the retrospective vector Va is a resultant vector that combines: a vector Va1 to be requested as production efficiency (hereinafter referred to as “production efficiency request vector Va1”); a vector Va2 to be requested as achievement efficiency (hereinafter referred to as “achievement efficiency request vector Va2”); and a vector Va3 to be requested as quality efficiency (hereinafter referred to as “quality efficiency request vector Va3”).

Therefore, the retrospective vector Va can be set by individually setting each of the production efficiency request vector Va1, the achievement efficiency request vector Va2, and the quality efficiency request vector Va3.

The technique for setting the production efficiency request vector Va1 is not limited in particular. For example, in a case of allocating the staff members in descending order of the productivity and the shift-working hours, and in ascending order of the cost (hourly rates), it is possible to employ a technique to set the production efficiency request vector Va1 by representing the vector length as a demand fulfillment percentage (%) in relation to the required number of staff to be allocated on that day.

In this case, each of the achievement efficiency request vector Va2 and the quality efficiency request vector Va3 is similarly set. Namely, a technique employed herein sets each of the achievement efficiency request vector Va2 and the quality efficiency request vector Va3 by representing the vector length as a demand fulfillment percentage (%) in relation to the required number of staff to be allocated on that day.

However, as shown in FIGS. 6 and 7, the reverse vectors Vb and Vc, which respectively represent the regulation compliance and the equitability rules, are subtracted from the ROI retrospective vector Va; and a vector resulting therefrom is an actual index vector when the staff members are actually allocated (hereinafter referred to as “actual index vector”).

Here, although not illustrated, if the ending points of the vectors are represented as “the production efficiency, the achievement efficiency, and the quality efficiency”, vectors are defined for each operator, by drawing lines from the coordinate origin to the dots of the production efficiency of each operator, the achievement efficiency of each operator, and “the quality efficiency of each operator”. Such a vector defined for each operator is hereinafter referred to as the operator vector.

In this case, the actual index vector is compared with each operator vector; and an operator having a highly similar operator vector is selected as a staff member.

For example, if eight staff members are selected, staff members, who rank first to eighth in the similarity between the index vector and the operator vector, are selected.

However, the algorithm for calculating the similarity of vectors may be complicated, and therefore, the calculation may require time.

Accordingly, for example, such as the three spheres shown in FIG. 6, permissible ranges are set in advance, based on the ROI retrospective vector Va, and the operators whose operator vectors fall within the permissible range may be selected as staff members.

Further, in order to further simplify the calculation of the personnel allocation planning, the ROI assignment unit 5 can set priority for each of (A) the production efficiency, (B) the achievement efficiency, and (C) the quality efficiency of the ROI.

Specifically, for example, assume that the ROI assignment unit 5 sets the following: (A) the production efficiency is the first priority; (C) the quality efficiency is the second priority; and (B) the achievement efficiency is the third priority.

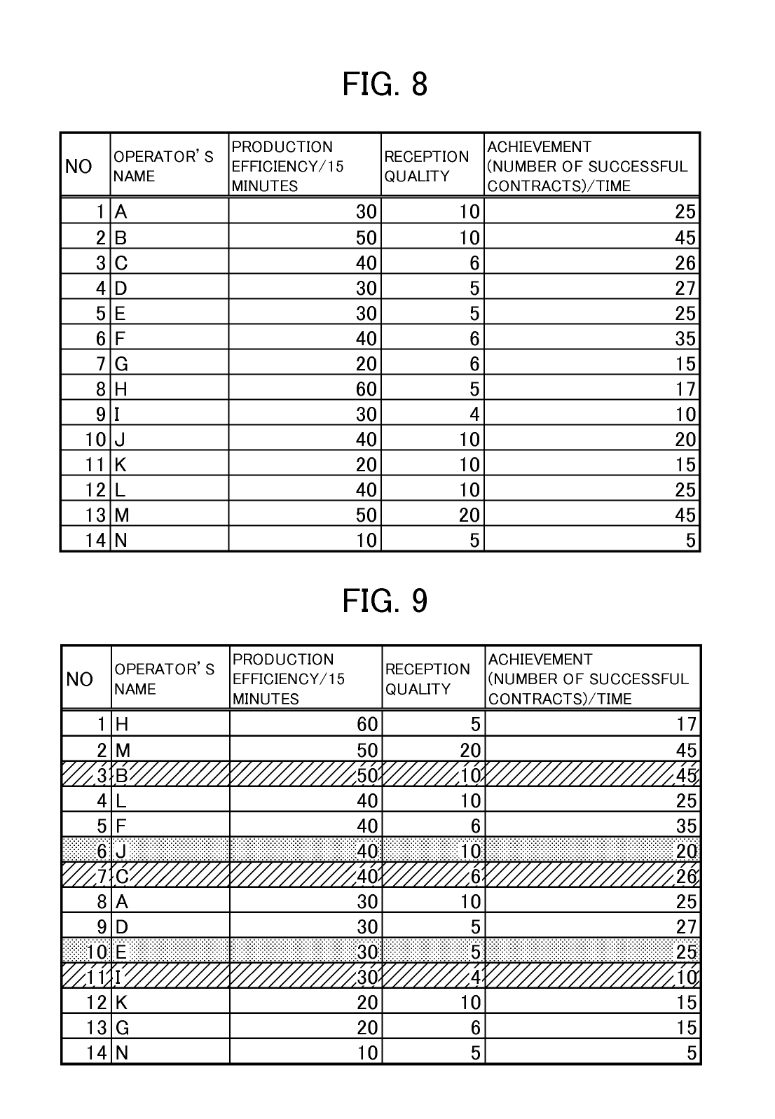

FIG. 8 is a table showing each of (A) the production efficiency, (B) the achievement efficiency, and (C) the quality efficiency, for each operator to be allocated as a staff member.

FIG. 8 shows the following for each operator in ascending order of the numbers (for example, employee numbers) being assigned to each operator: (A) “production efficiency/15 minutes” as an example of the production efficiency; (C) “reception quality” as an example of the quality efficiency; and (B) “result (the number of successful contracts)/time” as an example of the achievement efficiency.

In this case, the personnel allocation unit 1 can select the staff members by sorting the data in the table.

Specifically, for example, assume that ten staff members are required, and 80% (namely, eight staff members) are selected from the operators shown in the table of FIG. 8, in accordance with the ROI setting.

The personnel allocation unit 1 sorts the data in the table of FIG. 8 in descending order of the priority, thereby creating a table of FIG. 9.

FIG. 9 is a table showing each of (A) the production efficiency, (B) the achievement efficiency, and (C) the quality efficiency, for each operator to be allocated as a staff member, in which the data in the table is sorted in descending order of the ROI in consideration of the priority.

As shown in FIG. 9, first of all, each operator is sorted in descending order of (A) the production efficiency being the first priority. Next, plural operators, who rank the same in (A) the production efficiency, are sorted in descending order of (C) the quality efficiency being the second priority. Further, plural operators, who rank the same in both of (A) the production efficiency and (C) the quality efficiency, are sorted in descending order of (B) the achievement efficiency being the third priority.

Such a technique to sort the operators in the table (list) represents a technique to sort the operators in descending order of the similarity between the ideal index vector and the operator vector.

Here, in order to assure the compliance of the regulations regarding the protection of workers, such as the Japanese Labor Standard Law, the labor-management agreement under the same Law, Article 36, etc., the law compliance calculation unit 4 identifies operators whose working hours exceed the statutory working hours. In the example of FIG. 9, such operators B, C and I are identified, being indicated with diagonal strokes rising from bottom left to top right.

In terms of the weight on each condition for the equitability regarding the protection of workers (i.e. the degree to which the regulations should be observed), the equitability calculation unit 3 sets, for example, a five-day week rule, and identifies operators who are in contravention of the rule. In the example of FIG. 9, such operators J and E are identified, being shaded with fine dots.

Next, the personnel allocation unit 1 excludes the operators, who were identified as having constraints by the law compliance calculation unit 4 or the equitability calculation unit 3, from the candidate staff members.

Namely, as shown in FIGS. 6 and 7, this is equivalent to excluding the operators, based on the actual index vector resulting from subtracting the reverse vectors Vb and Vc, which respectively represent the regulation compliance and the equitability rules, from the ROI retrospective vector Va.

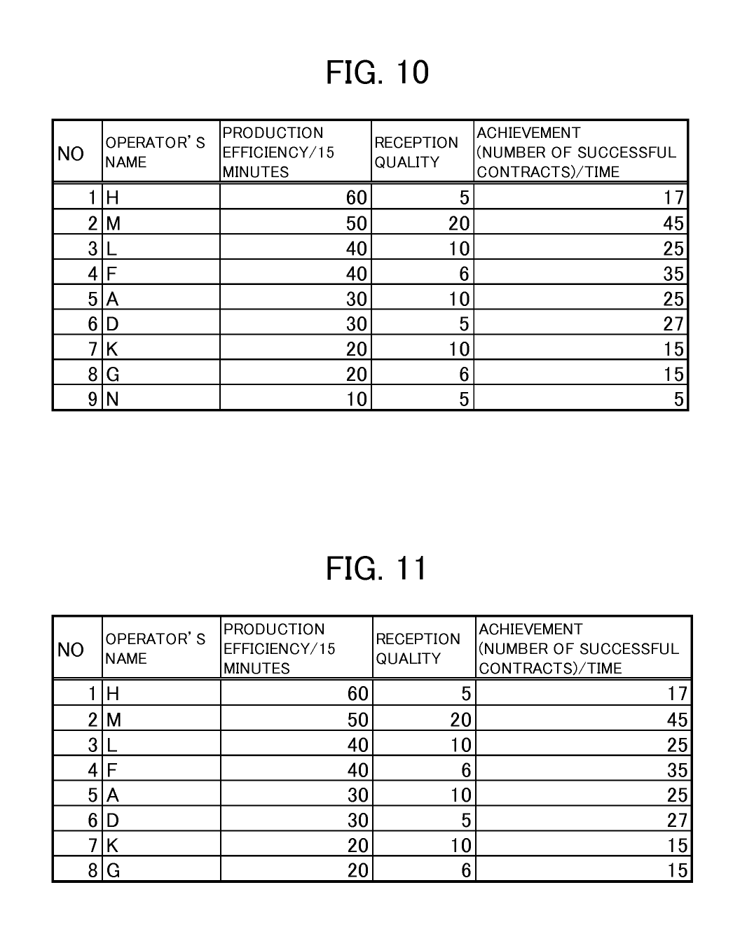

FIG. 10 shows a table, excluding the operators who were identified as having constraints from the table of FIG. 9.

Namely, the table of FIG. 10 excludes the operators B, C and I indicated with diagonal strokes rising from bottom left to top right in FIG. 9; and excludes the operators J and E shaded with fine dots in FIG. 9.

Here, as a prerequisite, ten staff members are required, and 80% (namely, eight staff members) are selected from the operators shown in the table of FIG. 8, in accordance with the ROI setting.

Therefore, the personnel allocation unit 1 selects and extracts eight operators as staff members in descending order, from the nine operators included in the table of FIG. 10.

FIG. 11 is a table showing the eight operators who were selected as staff members by the personnel allocation unit 1 in this manner.

Further, another specific technique of the personnel allocation planning is described below.

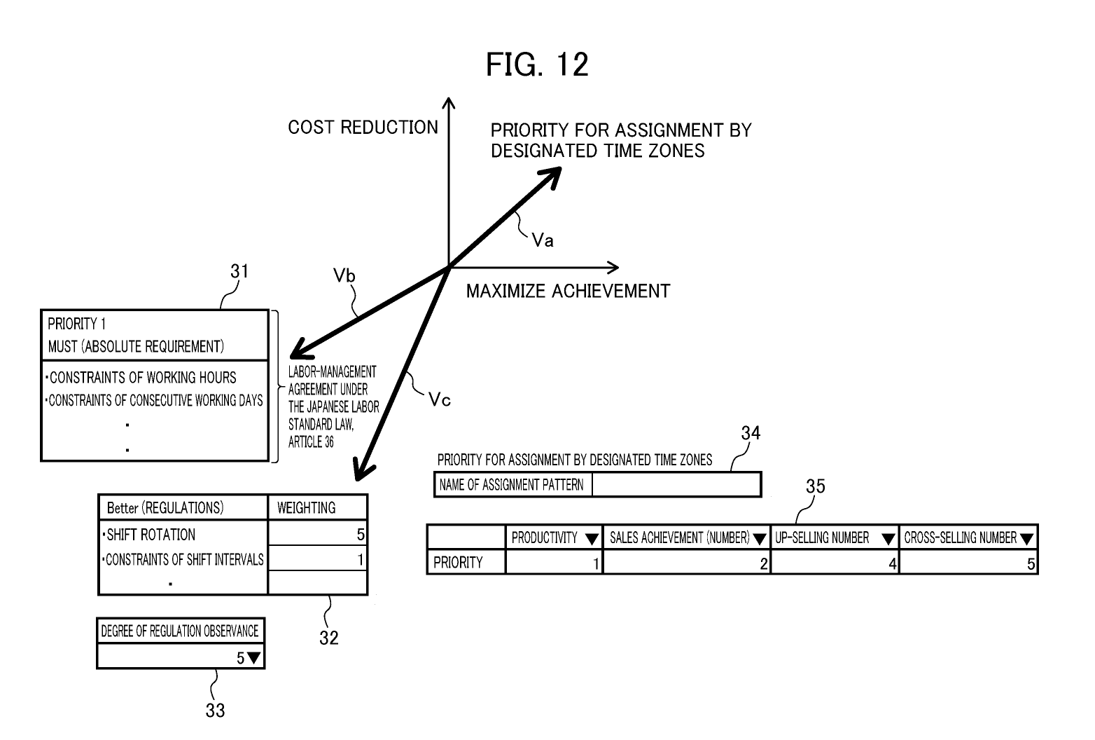

FIG. 12 shows a specific technique of the personnel allocation planning through the PPM, to which the present invention is applied.

The administrator or the like can set priority for assignment by designated time zones.

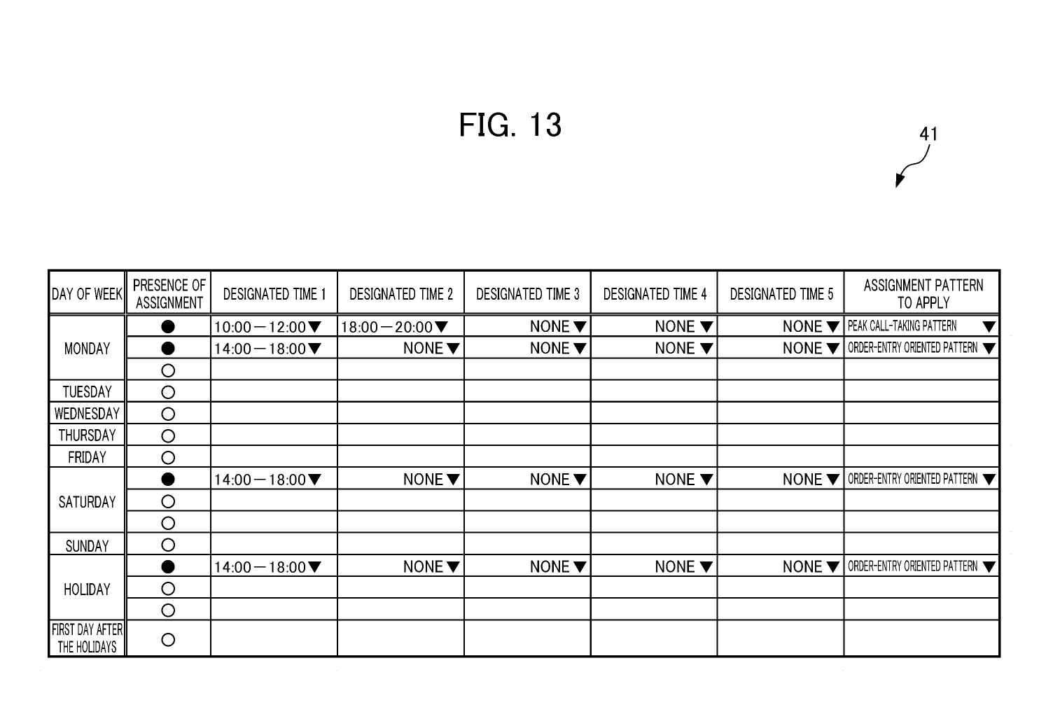

The administrator or the like can arbitrarily set the designated time zone, which will be described later with reference to FIG. 13. For example, it is possible to arbitrarily set the designated time zone, such as a first time zone from 10:00 to 11:00 of every Friday, and a second time zone from 3:00 to 5:00 on weekdays.

The administrator or the like can set an assignment pattern for the priority and allocation of each of the ROI factors, by inputting the priority of (A) the production efficiency, (B) the achievement efficiency, and (C) the quality efficiency, into an input box 35, for each designation time zone. In the present embodiment, the allocation is uniformly set in accordance with the priority; however, the allocation may be set separately. For the purpose of illustration, in the example of the input box 35 of FIG. 12, the priority is input in terms of the “productivity” corresponding to (A) the production efficiency, and the “sales achievement (number), the “up-selling number” and the “cross-selling number” corresponding to (B) the achievement efficiency. Naturally, the priority can also be input in terms of (C) the quality efficiency.

In other words, the “productivity” corresponding to the cost reduction of FIG. 12 is a compulsory input item; whereas the other three items can be freely designated by the administrator or the like. Namely, in the example of FIG. 12, only the “sales achievement (number), the “up-selling number” and the “cross-selling number” are set, in relation to (B) the achievement efficiency and (C) the quality efficiency.

Here, the “upward triangle” and “downward triangle” in each item of the input box designate the ascending or descending order of assigning the staff members, when allocating the staff members from the perspective of the item.

The administrator or the like can use an input box 34 to assign a desired name of a single time zone (hereinafter referred to as “assignment pattern name”) to the assignment pattern that was set by way of the input box 35.

Namely, regarding a predetermined time zone on a predetermined day, the ROI assignment unit 5 assigns priority and allocation to each of the ROI factors calculated by the individual efficiency calculation unit 2, based on the associated assignment pattern (pattern identified by way of a predetermined assignment pattern name), thereby generating the vector Va of FIG. 6.

The law compliance calculation unit 4 generates the Vector Vb by using, for example, a condition 31, as a condition for the protection of workers, such as the Japanese Labor Standard Law, the labor-management agreement under the same Law, Article 36, etc. Note that the condition 31 complies with the law, and is therefore set in advance.

The equitability calculation unit 3 calculates the weight on each condition (regulations) for the equitability (i.e. the degree to which the regulations should be observed) from a weighting table 32; and specifies the degree to which the regulations should be observed (hereinafter referred to as the “regulation observance degree”) from a regulation observance degree setting table 33. The equitability calculation unit 3 generates the vector Vc, based on the weight and the regulation observance degree, for each condition (regulations) for the equitability.

The personnel allocation unit 1 combines: the vector Va as the ROI index, based on the priority of assignment by designated time zones; the vector Vb as the law compliance index, in relation to the protection of workers; and the vector Vc as the equitability index, in relation to the protection of workers; and the personnel allocation unit 1 creates the personnel allocation planning, based on the resultant vector.

Next, designated time is described with reference to FIGS. 13 to 16, to which such assignment is applied.

FIG. 13 is a list of designated time, to which the assignment is applied. Namely, the time zone designation unit 6 of FIG. 1 designates each designated time zone, and can create a list or the like as shown in FIG. 13, as necessary.

In the example of FIG. 13, three patterns can be applied to one day. Note that, naturally, the type of assignment patterns applicable to one day is not limited to three.

Up to five arbitrary designated times can be set to a predetermined assignment pattern of a predetermined day.

Note that, in the example of FIG. 13, a single predetermined day is listed on the basis of every particular day of the week; however, each day may be listed on the basis of, without limitation, an actual day (such as, x^{th} day of x^{th} month).

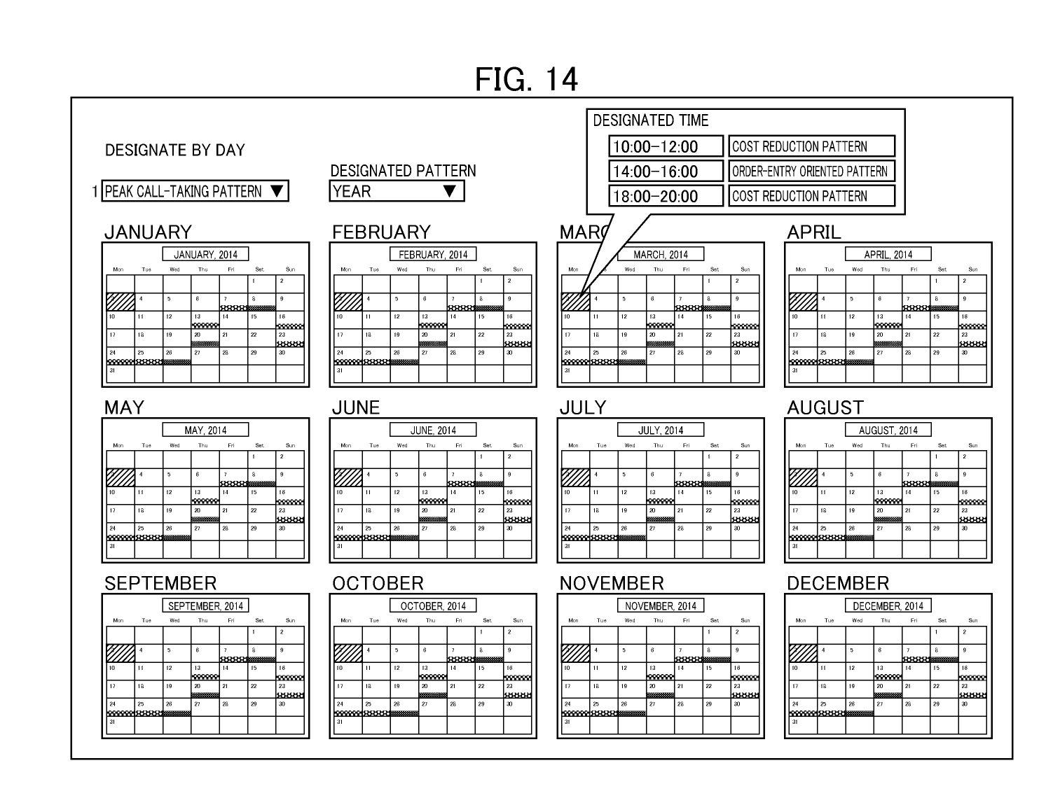

FIGS. 14 to 16 show a GUI for the administrator or the like to designate the designated time, to which the assignment is applied.

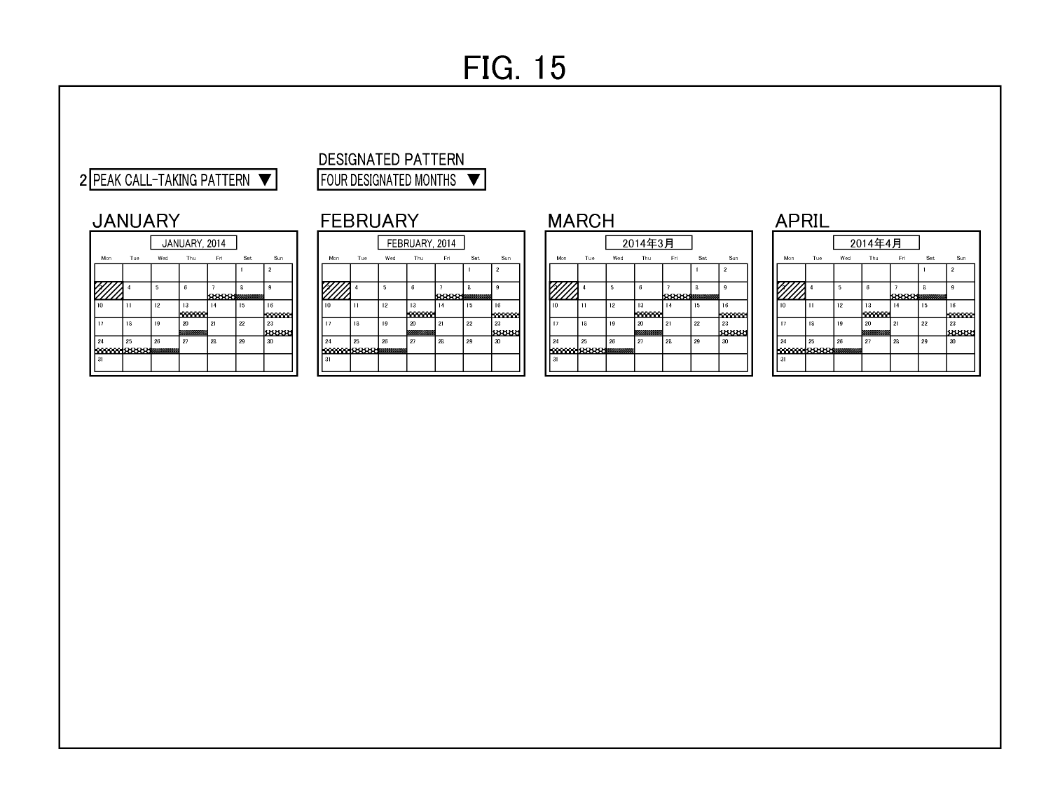

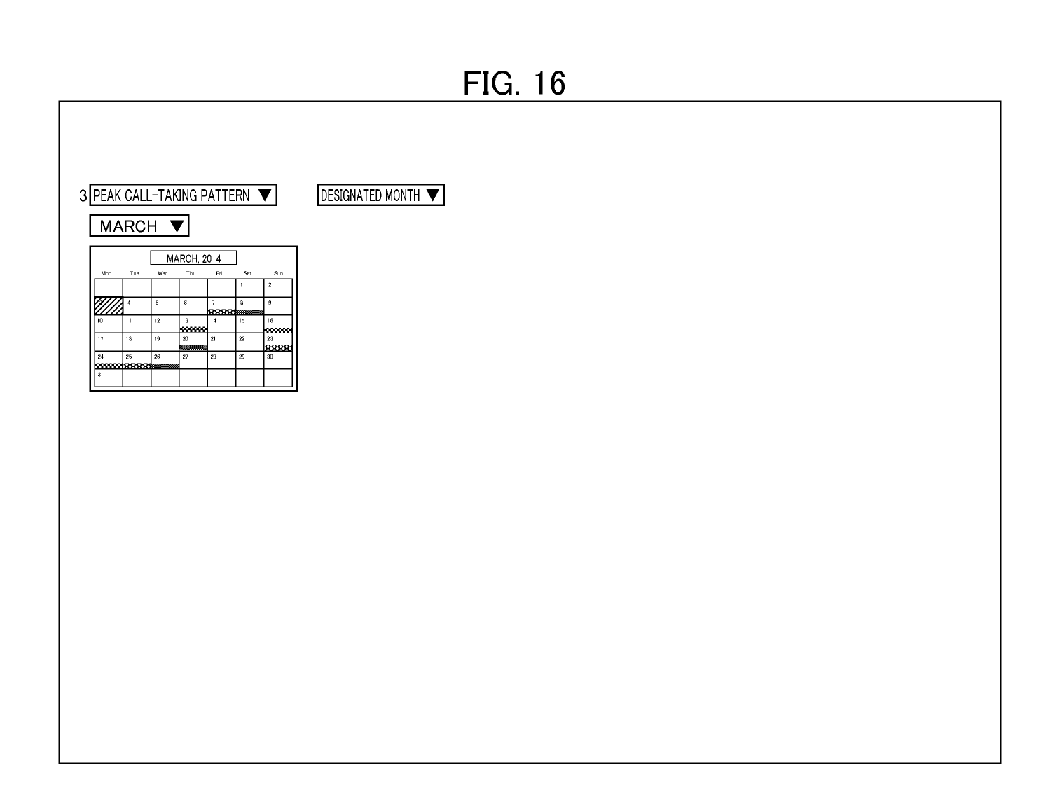

As shown in FIGS. 14 to 16, the administrator or the like can select a single predetermined assignment pattern from: a year (FIG. 14); four designated months (FIG. 15); and a designated month (FIG. 16). Namely, when the “year” (FIG. 14) is set, the designation is enabled on a yearly basis; when the “designated four months” (FIG. 15) is set, the designation is enabled on the designated four-month basis; and when the “designated month” (FIG. 16) is set, the designation is enabled on the designated monthly basis.

By clicking a desired day from any of the calendars shown in FIGS. 14 to 16, the administrator or the like can individually set a predetermined number of (in this example, three) desired time zones (as far as the range does not overlap) and desired assignment patterns, for the desired day.

The embodiment of the present invention has been described above, is merely illustrations of specific examples, and does not limit the present invention, in particular. The effects described in the embodiment of the present invention are merely an enumeration of the most preferable effects arising from the present invention; and the effects of the present invention are not limited to the effects described in the embodiment of the present invention.

### EXPLANATION OF REFERENCE NUMERALS

1 personnel allocation unit
2 individual efficiency calculation unit
3 equitability calculation unit
4 law compliance calculation unit
5 ROI assignment unit
6 time zone designation unit

1. A personnel allocation planning device for planning allocation of staff members at a contact center, the device comprising:
an efficiency calculation unit that calculates three factors composed of production efficiency, achievement efficiency and quality efficiency, as factors for return on investment on each individual of a plurality of staff members at the contact center; and
a personnel allocation unit that calculates three indexes corresponding to the three factors, based on a result of calculation by the efficiency calculation unit, compares the three indexes with the three factors for each of the plurality of staff members, and plans allocation of each of the plurality of staff members, based on a result of the comparison.

2. The personnel allocation planning device according to claim 1,
wherein the personnel allocation unit compares an operator vector composed of the three factors, and an index vector composed of the three indexes, for each of the plurality of staff members; and plans allocation of each of the plurality of staff members, based on a result of the comparison.

3. The personnel allocation planning device according to claim 1,
further comprising an assignment unit that determines an assignment degree regarding the three factors;
wherein the personnel allocation unit compares the three indexes with the three factors for each of the plurality of staff members, based on the result of calculation by the efficiency calculation unit, and based on the assignment degree determined by the assignment unit; and calculates the indexes of return on investment, based on a result of the comparison.

4. The personnel allocation planning device according to claim 3,
further comprising a time zone designation unit that designates at least one time zone, for which the three indexes of return on investment are calculated;
wherein the assignment unit determines the assignment degree for each of the at least one time zone designated by the time zone designation unit; and
wherein the personnel allocation unit calculates the three indexes of return on investment, based on the assignment degree determined by the assignment unit, for each of the at least one time zone designated by the time zone designation unit.

5. The personnel allocation planning device according to claim 1,
further comprising a regulation compliance calculation unit that calculates a condition for compliance to regulations regarding workers;
wherein the personnel allocation unit calculates a regulation compliance index, based on a result of calculation by the regulation compliance calculation unit; and plans allocation of each of the plurality of staff members, based on the regulation compliance index, and based on the three indexes of return on investment.

6. The personnel allocation planning device according to claim 5,
further comprising an equitability calculation unit that calculates a condition for equitability of workers,
wherein the personnel allocation unit calculates an equitability index, based on a result of calculation by the equitability calculation unit; and plans allocation of each of the plurality of staff members, based on the equitability index, and based on the three indexes of return on investment and the regulation compliance index.

7. A personnel allocation planning method that is executed by a personnel allocation planning device for planning allocation of staff members at a contact center, the method comprising:
an efficiency calculation step of calculating three factors composed of production efficiency, achievement efficiency and quality efficiency, as factors for return on investment on each individual of a plurality of staff members at the contact center; and
a personnel allocation step of calculating three indexes corresponding to the three factors, based on a result of calculation in the efficiency calculation step, compares the three indexes with the three factors for each of the plurality of staff members, and plans allocation of each of the plurality of staff members, based on a result of the comparison.

8. A program for causing a computer that controls a personnel allocation planning device for planning allocation of staff members at a contact center, the program causing the computer to execute the control processes comprising:
an efficiency calculation step of calculating three factors composed of production efficiency, achievement efficiency and quality efficiency, as factors for return on investment on each individual of a plurality of staff members at the contact center; and
a personnel allocation step of calculating three indexes corresponding to the three factors, based on a result of calculation in the efficiency calculation step, compares the three indexes with the three factors for each of the plurality of staff members, and plans allocation of each of the plurality of staff members, based on a result of the comparison.
